(19) United States
(12) Patent Application Publication
(10) Pub. No.: US 2013/0063201 A1
(43) Pub. Date: Mar. 14, 2013

(54) REFERENCE VOLTAGE CIRCUIT

(71) Applicant: Masakazu SUGIURA, Chiba (JP)

(72) Inventor: Masakazu SUGIURA, Chiba (JP)

(73) Assignee: SEIKO INSTRUMENTS INC., Chiba-shi (JP)

(21) Appl. No.: 13/604,149

(22) Filed: Sep. 5, 2012

(30) Foreign Application Priority Data
Sep. 9, 2011 (JP) 2011-197357

(51) Int. Cl. G05F 1/10

(52) U.S. Cl. 327/513

(57) ABSTRACT

Provided is a reference voltage circuit for generating a low constant voltage (1.25 V or lower) having less temperature dependence. The reference voltage circuit includes: a bandgap voltage generation circuit including two PN junctions, for outputting a voltage (Vk) which is based on any one of the two PN junctions and a current (Ik) which is based on a voltage difference between the two PN junctions; and a voltage divider circuit for dividing the voltage (Vk). The voltage divider circuit corrects a divided voltage based on the current (Ik) input thereto, and outputs the corrected divided voltage as a reference voltage.

### RELATED APPLICATIONS

This application claims priority under 35 U.S.C. §119 to Japanese Patent Application No. 2011-197357 filed on Sep. 9, 2011, the entire content of which is hereby incorporated by reference.

### BACKGROUND OF THE INVENTION

1. Field of the Invention

The present invention relates to a reference voltage circuit for generating a constant voltage having less temperature dependence.

2. Description of the Related Art

Conventionally, as a reference voltage circuit for generating a constant voltage having less temperature dependence, there is known a bandgap reference voltage circuit for generating a voltage which is substantially equal to a bandgap value of silicon (see, for example, Japanese Patent Application Laid-open No. 2008-305150).

FIG. 4 is a configuration diagram illustrating a conventional bandgap reference voltage circuit. The conventional bandgap reference voltage circuit includes a PN junction 401, a PN junction 402, a resistor 403 having a resistance value R1, a transistor 404, a transistor 405, a transistor 406, a resistor 407 having a resistance value R2 which is of the same type as the resistor 403 (which has equal temperature characteristics), a PN junction 408, and an amplifier 409. The PN junction 401 and the PN junction 402 have a relationship in which an effective area ratio (for example, an anode-cathode junction area ratio) is 1:K1.

The transistor 404 and the transistor 405 have the same gate-source voltage, and hence a current based on the size ratio flows therethrough. For example, when the size ratio is 1:1, substantially equal currents flow through the transistor 404 and the transistor 405. It is herein assumed that the current of the transistor 404 and the current of the transistor 405 are substantially equal to each other. The amplifier 409 controls the currents flowing through the transistor 404 and the transistor 405 so that a voltage VA and a voltage VB may be equal to each other. In this case, a current Ib flowing through the transistor 405 is expressed by Expression (1).

Ib=Vt×{ln(K1)}/R1 (1)

In Expression (1), VT represents a thermal voltage and is expressed by kT/q, where q represents the unit electron charge, k represents the Boltzmann constant, and T represents the absolute temperature.

A current based on the current Ib flows through the transistor 406. When the size ratio between the transistor 405 and the transistor 406 is 1:1, and a voltage generated at the PN junction 408 is represented by a voltage Vpn3, a reference voltage Vref is expressed by Expression (2).

Vref=Vpn3+(R2/R1)×VT×{ln(K1)} (2)

The first term exhibits a negative temperature characteristic because the voltage Vpn3 has a negative temperature characteristic of about −2.0 mV/° C. The second term exhibits a positive temperature characteristic because the thermal voltage VT has a positive temperature characteristic.

Expression (2) is differentiated with respect to T, and the condition in which Vref becomes zero is obtained as expressed by Expression (3).

(R2/R1)×(k/q)×{ln(K1)}=0.002 (3)

Therefore, by setting (R2/R1) so as to satisfy Expression (3), it is possible to realize a reference voltage Vref having no temperature dependence.

In this manner, a reference voltage circuit for generating a voltage having less temperature dependence can be obtained.

In the conventional bandgap reference voltage circuit, however, the reference voltage Vref is about 1.25 V based on Expressions (2) and (3). Therefore, there has been a problem in that an operating voltage cannot be set equal to or lower than a voltage which is limited by the reference voltage Vref.

### SUMMARY OF THE INVENTION

The present invention has been made in order to solve the above-mentioned problem, and realizes a reference voltage circuit for generating a lower voltage having less temperature dependence.

A reference voltage circuit according to the present invention includes: a bandgap voltage generation circuit including two PN junctions, for outputting a voltage Vk which is based on the two PN junctions and a current Ik which is based on a voltage difference between the two PN junctions; and a voltage divider circuit for dividing the voltage Vk. The voltage divider circuit corrects a divided voltage based on the current Ik input thereto, and outputs the corrected divided voltage as a reference voltage.

The present invention can provide the reference voltage circuit for generating a lower reference voltage having less temperature dependence.

### BRIEF DESCRIPTION OF THE DRAWINGS

In the accompanying drawings:

FIG. 1 is a configuration diagram illustrating a reference voltage circuit according to a first embodiment of the present invention;

FIG. 2 is a configuration diagram illustrating a reference voltage circuit according to a second embodiment of the present invention;

FIG. 3 is a configuration diagram illustrating a reference voltage circuit according to a third embodiment of the present invention; and

FIG. 4 is a configuration diagram illustrating a conventional bandgap reference voltage circuit.

### DETAILED DESCRIPTION OF THE PREFERRED EMBODIMENTS

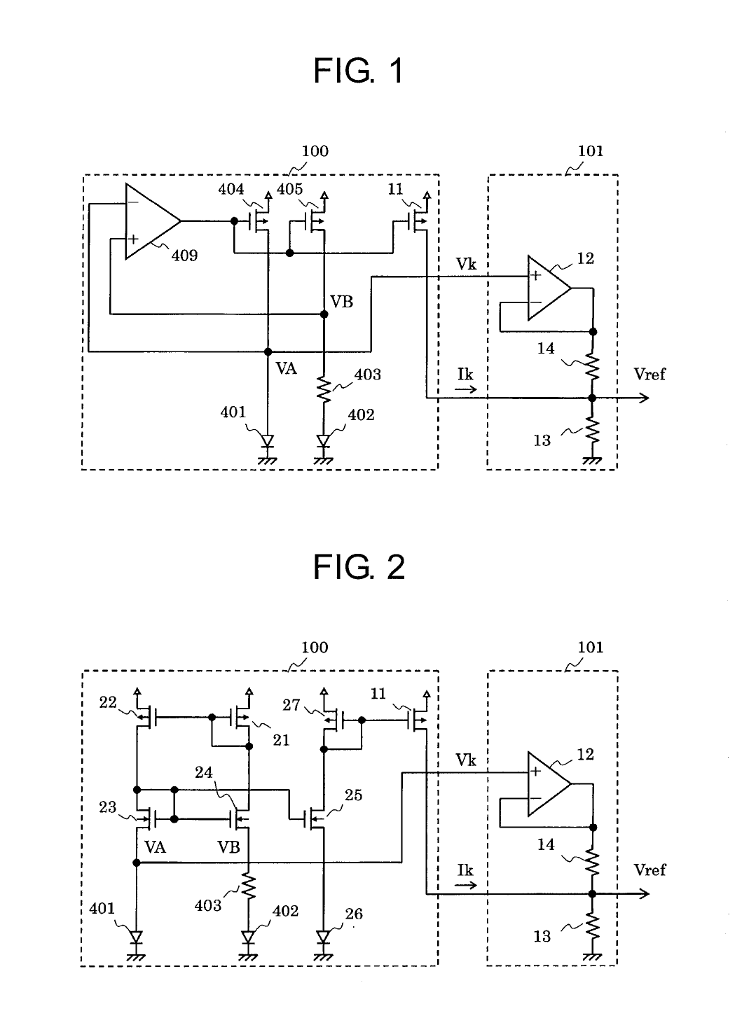

FIGS. 1 to 3 are configuration diagrams each illustrating a reference voltage circuit according to embodiments of the present invention.

The reference voltage circuit according to the embodiments of the present invention includes a bandgap voltage generation circuit 100 and a voltage divider circuit 101. The bandgap voltage generation circuit 100 generates and outputs a voltage Vk and a current Ik based on voltages of two PN junctions (having a relationship in which an effective area ratio, for example, an anode-cathode junction area ratio is 1:K1). The voltage divider circuit 101 outputs a reference voltage Vref based on the voltage Vk and the current Ik which are input from the bandgap voltage generation circuit 100.

### First Embodiment

FIG. 1 illustrates a configuration diagram of a reference voltage circuit according to a first embodiment of the present invention.

A bandgap voltage generation circuit 100 includes PN junctions 401 and 402, a resistor 403, transistors 404 and 405, an amplifier 409, and a transistor 11. A voltage divider circuit 101 includes an amplifier 12 and resistors 13 and 14.

The transistor 404 and the PN junction 401 are connected in series between a power source and the ground. The transistor 405, the resistor 403, and the PN junction 402 are connected in series between the power source and the ground. The amplifier 409 has an inverting input terminal connected to a node between the transistor 404 and the PN junction 401. The amplifier 409 has a non-inverting input terminal connected to a node between the transistor 405 and the resistor 403. The amplifier 409 has an output terminal connected to a gate terminal of each of the transistor 404, the transistor 405, and the transistor 11.

As a voltage Vk based on the PN junctions, a voltage VA generated at the PN junction 401 is used. As a current Ik based on the PN junctions, a current supplied by the transistor 11, whose gate terminal is connected in common to the gate terminals of the transistor 404 and the transistor 405, is used.

The amplifier 12 has an inverting input terminal to which the voltage Vk is input. An output terminal and an inverting input terminal of the amplifier 12 are connected to each other. The resistors 13 and 14 are connected in series between the output terminal of the amplifier 12 and the ground. A node between the resistors 13 and 14 is connected to a drain terminal of the transistor 11, and is connected to an output terminal of the reference voltage circuit.

Now, the operation of the reference voltage circuit according to this embodiment is described.

The amplifier 409 controls currents flowing through the transistor 404 and the transistor 405 so that the voltage VA and a voltage VB may be equal to each other.

A current Ib flowing through the transistor 405 is a value obtained by dividing a voltage difference between a voltage Vpn1 generated at the PN junction 401 and a voltage Vpn2 generated at the PN junction 402 by a resistance value R1 of the resistor 403. In other words, the current Ib based on the voltage difference of the two PN junctions flows through the transistor 405.

In this case, the transistor 11 and the transistor 405 have the same gate-source voltage, and hence a current based on the size ratio flows therethrough. For example, when the size ratio is 1:1, substantially equal currents Ib flow through the transistor 11 and the transistor 405. In other words, the current Ik, which is equal to the current Ib based on the voltage difference of the two PN junctions, flows through the transistor 11.

The current Ik flowing through the transistor 11 is expressed by Expression (4).

Ik=VT×{ln(K1)/}R1 (4)

In Expression (4), VT represents a thermal voltage and is expressed by kT/q, where q represents the unit electron charge, k represents the Boltzmann constant, and T represents the absolute temperature.

The voltage Vref is expressed by Expression (5).

Vref=Ik×(R3×R4)/(R3+R4)+Vk×R3/(R3+R4)={R3/(R3+R4)}×(R4/R1)×VT×{ln(K1)}+Vk} (5)

where R3 represents a resistance value of the resistor 13, and R4 represents a resistance value of the resistor 14.

In Expression (5), (R4/R1)×VT×{ln(K1)} exhibits a positive temperature characteristic because the thermal voltage VT has a positive temperature characteristic, and Vk exhibits a negative temperature characteristic because Vpn1 has a negative temperature characteristic of about −2.0 mV/° C. Therefore, through appropriate setting of (R4/R1), {(R4/R1)×VT×{ln(K1)}+Vk} in Expression (5) can have less temperature dependence. Then, merely through appropriate setting of {R3/(R3+R4)}, the reference voltage Vref can be obtained as a divided voltage of {(R4/R1)×VT×{ln(K1)}+Vk} in Expression (5), whose absolute value can be set freely.

As described above, the reference voltage Vref of the reference voltage circuit according to the first embodiment can be obtained as a low voltage (1.25 V or lower) having less temperature dependence. Therefore, the operating voltage of the reference voltage circuit can also be reduced.

Note that, the reference voltage circuit of the first embodiment has a configuration in which the voltage Vk is subjected to impedance conversion by the amplifier 12, but, in the case where the impedance of the voltage Vk is low, the voltage Vk may be connected to the resistor 14 directly.

Further, in the reference voltage circuit of the first embodiment, as the voltage Vk based on the PN junctions, the voltage VA generated at the PN junction 401 is used, but the voltage VB or another voltage may be used.

Further, in the reference voltage circuit of the first embodiment, as a circuit for generating the voltage VB, the circuit configuration in which the PN junction 402 and the resistor 403 are connected in series in this order from the ground is used, but the same effect can be obtained even when the PN junction 402 and the resistor 403 are connected in the reverse order.

### Second Embodiment

FIG. 2 illustrates a configuration diagram of a reference voltage circuit according to a second embodiment of the present invention.

A bandgap voltage generation circuit 100 includes PN junctions 401 and 402, a resistor 403, transistors 21, 22, 23, 24, 25, and 27, a PN junction 26, and a transistor 11.

The PN junctions 401 and 402 and the resistor 403 are configured similarly to the reference voltage circuit of the first embodiment. The transistors 21 and 22 and the transistors 23, 24, and 25 form current mirror circuits, respectively. The transistor 27, the transistor 25, and the PN junction 26 are connected in series between a power source and the ground. The transistor 27 and the transistor 11 form a current mirror circuit.

The current mirror circuits allow equal currents to flow through the PN junctions 401 and 402 and the resistor 403, and hence a voltage VA and a voltage VB become equal to each other.

As a voltage Vk based on the PN junctions, the voltage VA generated at the PN junction 401 is used. As a current Ik based on the PN junctions, a current supplied by the PN junction 26 and the transistor 25, whose gate terminal is connected in common to the gate terminals of the transistor 23 and the transistor 24, is used.

Even by the reference voltage circuit of the second embodiment having the configuration illustrated in FIG. 2 described above, the same effect as in the reference voltage circuit of the first embodiment can be obtained.

Note that, the reference voltage circuit of the second embodiment has a configuration in which the voltage Vk is subjected to impedance conversion by the amplifier 12, but, in the case where the impedance of the voltage Vk is low, the voltage Vk may be connected to the resistor 14 directly.

Further, in the reference voltage circuit of the second embodiment, as the voltage Vk based on the PN junctions, the voltage VA generated at the PN junction 401 is used, but the voltage VB or another voltage may be used.

Further, in the reference voltage circuit of the second embodiment, as a circuit for generating the voltage VB, the circuit configuration in which the PN junction 402 and the resistor 403 are connected in series in this order from the ground is used, but the same effect can be obtained even when the PN junction 402 and the resistor 403 are connected in the reverse order.

### Third Embodiment

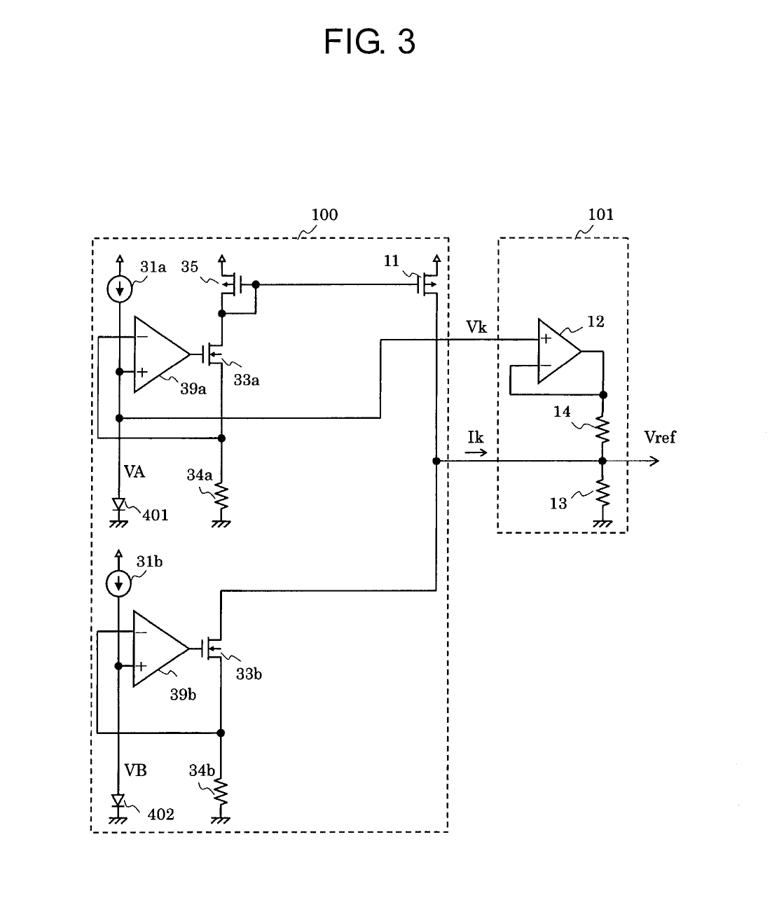

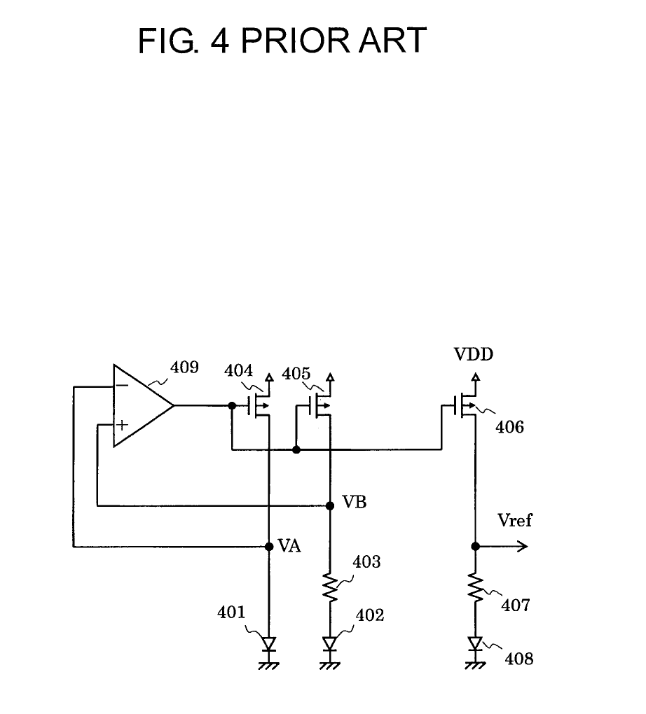

FIG. 3 illustrates a configuration diagram of a reference voltage circuit according to a third embodiment of the present invention.

A bandgap voltage generation circuit 100 includes current sources 31a and 31b, PN junctions 401 and 402, transistors 33a and 33b, resistors 34a and 34b, amplifiers 39a and 39b, and transistors 35 and 11.

The current source 31a and the PN junction 401 are connected in series between a power source and the ground, and a node therebetween is connected to a non-inverting input terminal of the amplifier 39a. The amplifier 39a has an output terminal connected to a gate terminal of the transistor 33a and an inverting input terminal connected to a source terminal of the transistor 33a. The transistors 35 and 33a and the resistor 34a are connected in series between the power source and the ground. The transistors 35 and 11 are current-mirror-connected.

The current source 31b and the PN junction 402 are connected in series between the power source and the ground, and a node therebetween is connected to a non-inverting input terminal of the amplifier 39b. The amplifier 39b has an output terminal connected to a gate terminal of the transistor 33b and an inverting input terminal connected to a source terminal of the transistor 33b. The transistors 11 33b and the resistor 34b are connected in series between the power source and the ground.

The transistor 33a and the resistor 34a allow a current Ia which is based on a voltage Vpn1 generated at the PN junction 401 to flow. The transistor 33b and the resistor 34b allow a current Ib which is based on a voltage Vpn2 generated at the PN junction 402 to flow.

In this case, as a voltage Vk based on the PN junctions, a voltage VA generated at the PN junction 401 is used. As a current Ik based on a voltage difference of the two PN junctions, a current obtained by subtracting the current Ib from the current Ia is used. From the above, the current Ik obtained by subtracting the current Ib from the current Ia is a current based on the voltage difference of the two PN junctions.

Even by the reference voltage circuit of the third embodiment having the configuration illustrated in FIG. 3 described above, the same effect as in the reference voltage circuit of the first embodiment can be obtained.

Note that, the reference voltage circuit of the third embodiment has a configuration in which the voltage Vk is subjected to impedance conversion by the amplifier 12, but, in the case where the impedance of the voltage Vk is low, the voltage Vk may be connected to the resistor 14 directly.

Further, in the reference voltage circuit of the third embodiment, as the voltage Vk based on the PN junctions, the voltage VA generated at the PN junction 401 is used, but a voltage VB or another voltage may be used.

What is claimed is:

1. A reference voltage circuit for outputting a constant voltage which is based on a voltage difference of two PN junctions, the reference voltage circuit comprising:
a bandgap voltage generation circuit for outputting a voltage Vk which is based on any one of the two PN junctions and a current Ik which is based on the voltage difference of the two PN junctions; and
a voltage divider circuit for dividing the voltage Vk,
wherein the voltage divider circuit corrects the divided voltage based on the current Ik input thereto, and outputs the corrected divided voltage as a reference voltage.

2. A reference voltage circuit according to claim 1, wherein the voltage divider circuit comprises a plurality of resistors connected between the voltage Vk and a ground,
wherein the current Ik is input to a node between the plurality of resistors.

3. A reference voltage circuit according to claim 1, wherein the voltage divider circuit comprises:
an amplifier including one input terminal to which the voltage Vk is input, and an output terminal connected to another input terminal of the amplifier; and
a plurality of resistors connected between the output terminal of the amplifier and a ground,
wherein the current Ik is input to a node between the plurality of resistors.
